(19) United States
(12) Patent Application Publication
(10) Pub. No.: US 2013/0113760 A1
(43) Pub. Date: May 9, 2013

(54) TECHNIQUES FOR PROVIDING LOCALIZED TACTILE FEEDBACK TO A USER VIA AN ELECTRO-ACOUSTIC TOUCH DISPLAY OF A USER DEVICE

(71) Applicants: Richard Carl Gossweiler, III, Sunnyvale, CA (US); Roy Want, Los Altos, CA (US)

(72) Inventors: Richard Carl Gossweiler, III, Sunnyvale, CA (US); Roy Want, Los Altos, CA (US)

(73) Assignee: GOOGLE INC., Mountain View, CA (US)

(21) Appl. No.: 13/290,367

(22) Filed: Nov. 7, 2011

(51) Int. Cl. G06F 3/043

(52) U.S. Cl. 345/177

(57) ABSTRACT

A user device is presented. The user device includes an interactive substrate configured to receive touch input from a user of the user device. The user device also includes a plurality of acoustic transducers, each of the plurality of acoustic transducers being configured to generate an acoustic wave along the interactive substrate in response to a control signal. The user device also includes a first circuit configured to sense a position of the touch input from the user with respect to the interactive substrate. The user device further includes a second circuit configured to generate the control signal for each of the plurality of acoustic transducers to generate a desired vibration at the position of the touch input.

### FIELD

The present disclosure relates to user devices and, more particularly, to techniques for providing localized tactile feedback to a user via an electro-acoustic touch display of a user device.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A “user device” generally refers to a computing device including a display, a user interface, and a processor. User devices may include stationary or non-portable user devices such as desktop computers. User devices may also include mobile devices such as mobile phones, tablet computers, and laptop computers. The display of a user device generally provides information to a user. The display, however, may also be a touch display such as a capacitive sensing display or the like. A user device having a touch display may also be referred to as a touch device. The touch display may both display information to the user and receive tactile input from the user. The user may typically provide the tactile input to the touch device by providing a touch input using one or more fingers.

### SUMMARY

A user device is presented. The user device includes an interactive substrate configured to receive touch input from a user of the user device. The user device also includes a plurality of acoustic transducers, each of the plurality of acoustic transducers being configured to generate an acoustic wave along the interactive substrate in response to a control signal. The user device also includes a first circuit configured to sense a position of the touch input from the user with respect to the interactive substrate. The user device further includes a second circuit configured to generate the control signal for each of the plurality of acoustic transducers to generate a desired vibration at the position of the touch input.

A system is also presented. The system includes a position determination module that determines, at a user device, a first position of a touch of a user with respect to a touch display of the user device. The system also includes a parameter determination module that determines, at the user device, one or more parameters for controlling a plurality of acoustic transducers of the touch display, the one or more parameters indicating a desired vibration to be felt by the user at the first position. The system further includes a control signal generation module that generates, at the user device, a control signal for each of the plurality of acoustic transducers. Generating the control signal includes determining a desired frequency of the control signal based on the one or more parameters. Generating the control signal also includes determining a desired amplitude of the control signal based on the one or more parameters. Generating the control signal also includes determining a desired phase of the control signal based on the first position of the touch of the user and a second position of one of the plurality of acoustic transducers associated with the control signal. Generating the control signal further includes generating the control signal based on the desired frequency, the desired amplitude, and the desired phase. The control signal generation module provides each control signal to its associated acoustic transducer to generate the desired vibration at the first position of the touch of the user.

A computer-implemented method is also presented. The computer-implemented method includes determining, at a user device, a first position of a touch of a user with respect to a touch display of the user device. The computer-implemented method also includes determining, at the user device, one or more parameters for controlling a plurality of acoustic transducers of the touch display, the one or more parameters indicating a desired vibration to be felt by the user at the first position. The computer-implemented method also includes generating, at the user device, a control signal for each of the plurality of acoustic transducers. Generating the control signal includes determining a desired frequency of the control signal based on the one or more parameters. Generating the control signal also includes determining a desired amplitude of the control signal based on the one or more parameters. Generating the control signal also includes determining a desired phase of the control signal based on the first position of the touch of the user and a second position of one of the plurality of acoustic transducers associated with the control signal. Generating the control signal further includes generating the control signal based on the desired frequency, the desired amplitude, and the desired phase. The computer-implemented method further includes providing each control signal to its associated acoustic transducer to generate the desired vibration at the first position of the touch of the user.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic illustration of interaction between a user and a user device according to some implementations of the present disclosure;

FIG. 2A is a schematic illustration of an electro-acoustic touch display of the user device of FIG. 1;

FIG. 2B is a sectional view of the electro-acoustic touch display of FIG. 2A along line A-A;

FIG. 3 is a functional block diagram of the user device of FIG. 1 including the electro-acoustic touch display of FIGS. 2A-2B;

FIG. 4A is a functional block diagram of a user interface module of FIG. 3;

FIG. 4B is a functional block diagram of a control signal generation module of FIG. 4A; and

FIG. 5 is a flow diagram of an example technique for providing localized tactile feedback to a user via an electro-acoustic touch display of a user device according to some implementations of the present disclosure.

### DETAILED DESCRIPTION

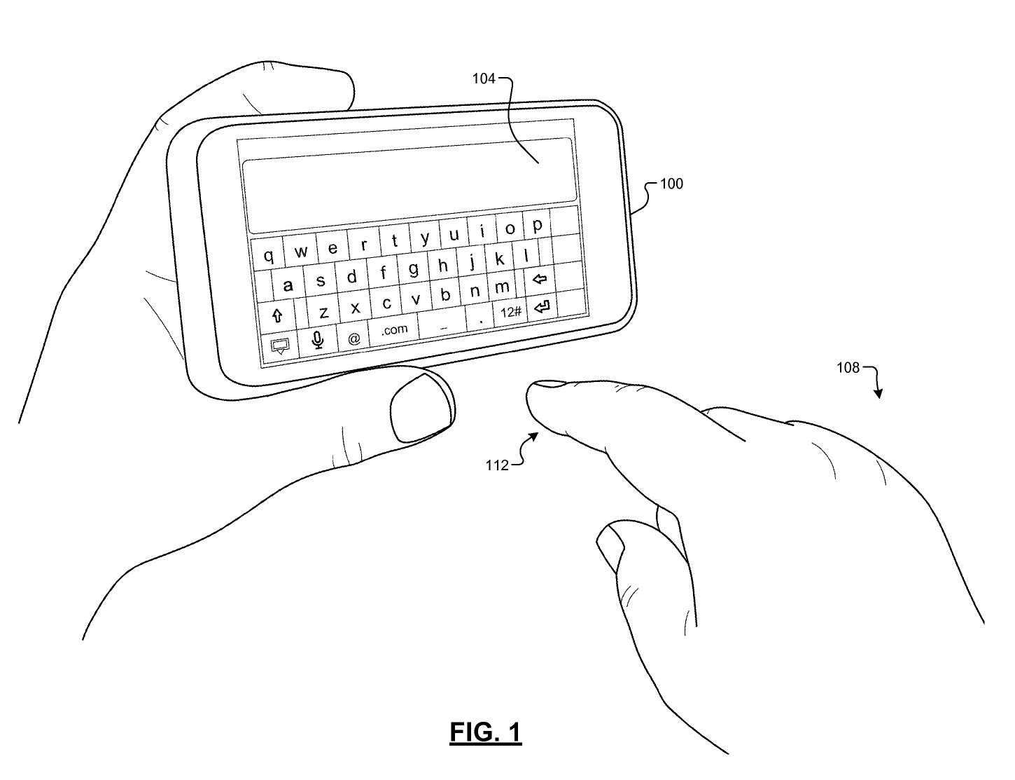

Referring now to FIG. 1, an example user device 100 is shown. As shown, the user device 100 may be a mobile device such as a mobile phone, a tablet computer, a portable music, movie, and/or gaming device, or a laptop computer. The user device 100, however, may also be a stationary or non-portable computing device such as a desktop computer. The user device 100 generally includes a display such as a touch display 104 (a capacitive sensing display or the like). The touch display 104 may display information to, and receive input from, a user 108. For example, the user 108 may input information to the user device 100 via the touch display 104 by touching or providing a touch input using one or more fingers 112.

The user device 100 may also provide tactile or haptic feedback to the user 108. The tactile feedback may include vibration of the user device 100. For example, tactile feedback may be provided after the user 108 performs a particular action such as pressing a button, e.g., a physical button on the user device 100 or a button or icon displayed via the touch display 104. Typical user devices, however, only provide general tactile feedback to the user 108. For example, general tactile feedback may include vibration of the entire user device 100. The user 108, therefore, may be unable to determine which of his or her actions caused the tactile feedback, e.g., in situations where the user intentionally or unintentionally presses more than one button at a single time.

Accordingly, techniques are presented for providing localized tactile feedback to a user via an electro-acoustic touch display of a user device. The techniques generally provide for more accurate tactile feedback by a user device, which provides for an improved user experience. The techniques can also independently provide tactile feedback to a plurality of different fingers of the user. The techniques include determining a first position of a touch of a user with respect to a touch display of a user device. For example, the techniques may determine the first position of the touch of the user with respect to an interactive substrate of an electro-acoustic touch display of a mobile device. As previously mentioned, the techniques may further determine a second position of a second touch of the user with respect to the touch display of the user device. The techniques may then determine one or more parameters indicating a desired vibration to be felt by the user at the first position. The techniques may further determine one or more parameters indicating a second desired vibration to be felt by the user at the second position. The one or more parameters, therefore, can include different sets of parameters for different touch inputs, e.g., different fingers of the user. In some implementations, however, the one or more parameters may be the same, e.g., indicating the same desired vibration to be felt by the user at the first and second positions. The one or more parameters may be previously input by the user and/or predefined, and therefore may be retrieved from memory. For example, the one or more parameters may include a first parameter indicating an intensity of the desired vibration and a second parameter indicating a texture of the desired vibration.

The techniques may then generate a control signal for each of a plurality of acoustic transducers. For example, the plurality of acoustic transducers may be arranged beneath and around the edge of the interactive substrate. The techniques may determine a desired frequency and/or a desired amplitude of the control signal based on the one or more parameters. The techniques may further determine a desired phase of the control signal based on the first position and a second position of one of the plurality of acoustic transducers corresponding to the control signal. The techniques may then generate the control signal based on the desired frequency, the desired amplitude, and the desired phase. The techniques may then provide each of the control signals to its associated acoustic transducer to provide the desired vibration at the first position of the touch of the user. As previously described, the techniques may also provide the second desired vibration at the second position of the second touch of the user. The techniques can generate a plurality of different vibrations at different locations with respect to the touch display by controlling the control signals supplied to the acoustic transducers. More specifically, the techniques can control the control signals to adjust an interference of the acoustic waves generated by the acoustic transducers, thereby adjusting a position of interference peaks and/or troughs.

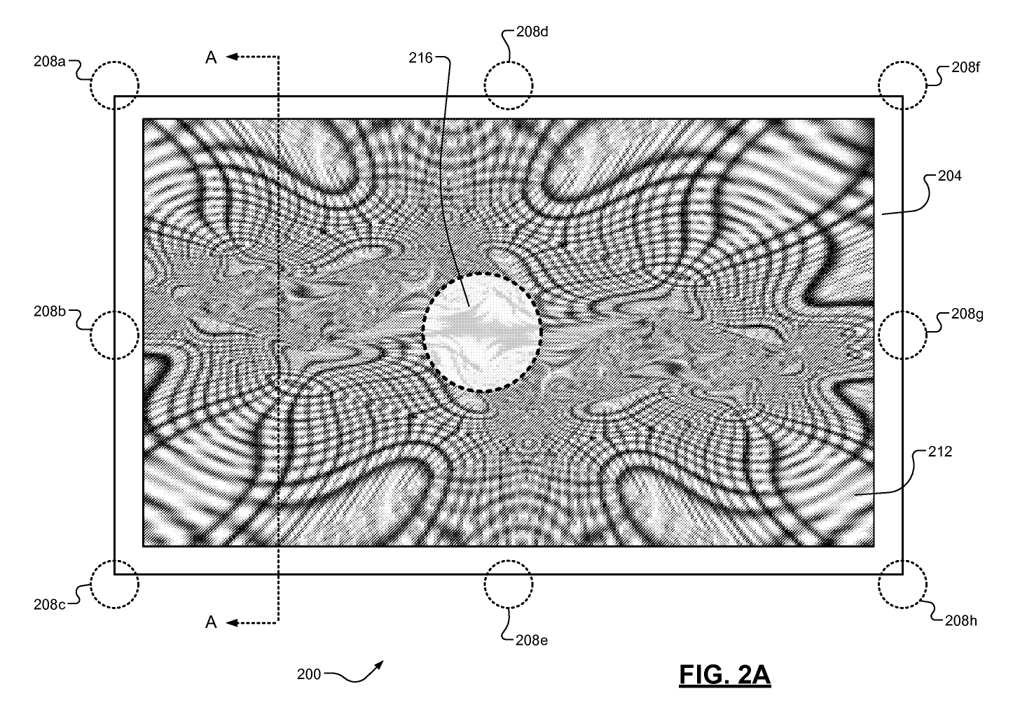

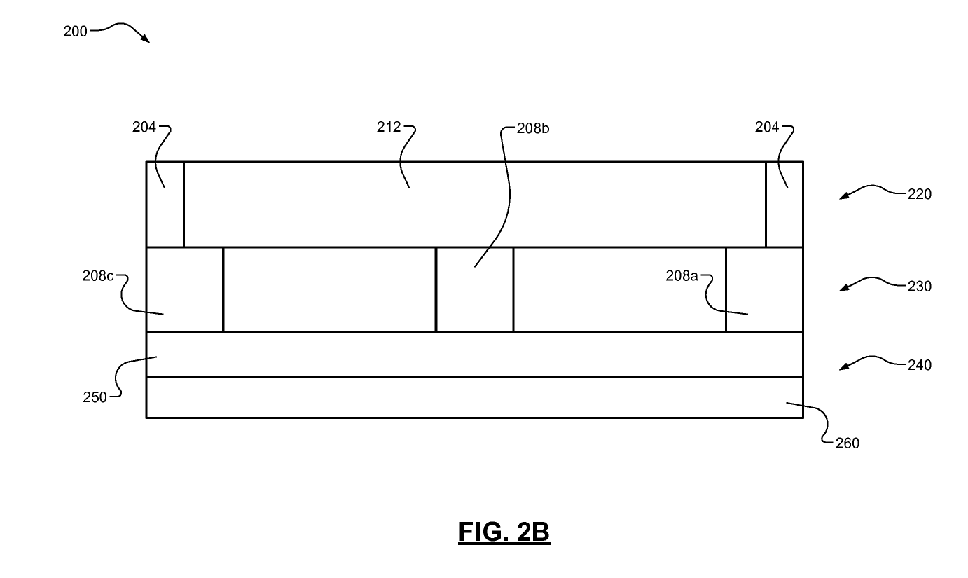

Referring now to FIG. 2A, an example electro-acoustic touch display 200 is illustrated. The example electro-acoustic touch display 200 may be implemented as the touch display 104 of user device 100 of FIG. 1. An “electro-acoustic touch display” hereinafter refers to a touch display including two or more acoustic transducers. The example electro-acoustic touch display 200 includes an acoustic dampening material 204, eight acoustic transducers 208a . . . 208h (hereinafter acoustic transducers 208), and an interactive substrate 212. While eight acoustic transducers 208 are shown, the electro-acoustic touch display 200 can include any number of n acoustic transducers (n>1).

The acoustic transducers 208 may be piezoelectric acoustic transducers 208. It should be appreciated, however, that the acoustic transducers 208 may be any suitable type of acoustic transducer such as other types of micro electromechanical system (MEMS) acoustic transducers and the like. Each of the acoustic transducers 208 may be actuated to generate an acoustic wave on the surface of the electro-acoustic touch display 200, e.g., on the interactive substrate 212. Alternatively, the acoustic waves may be generated in an air gap or a dielectric material below the surface of the interactive substrate 212 (described in more detail below). The acoustic dampening material 204 provides acoustic dampening to constrain the acoustic waves within the area of the interactive substrate 212 as shown, however, it should be appreciated that the acoustic transducers 208 may also be located at other locations (in a same layer as the interactive substrate 212, above the interactive substrate 212, in the center of the interactive substrate 212, etc.).

The interactive substrate 212 represents a layer of the electro-acoustic touch display 200 with which the user 108 interacts. As previously described, the electro-acoustic touch display 200 may be a capacitive sensing display and thus the touching of the interactive substrate 212 by the user 108 may vary a capacitance sensed by circuitry beneath the interactive substrate 212 (described in detail below). The interactive substrate 212 is typically a silicon or silicate based substrate such as glass, acrylic, or the like, but other materials may also be used for the interactive substrate. In addition, the interactive substrate 212 may further include coatings (not shown) such as coatings to prevent scratching and/or glare.

Each of the acoustic transducers 208 may be selectively controlled to adjust the interference of the acoustic waves on the surface of the electro-acoustic touch display 200. Controlling the interference of the acoustic waves may vary a position of vibration troughs (low intensity areas) and vibration peaks (high intensity areas, such as area 216). While one peak area 216 is shown, it should be appreciated that a plurality of different peak areas and/or trough areas can be generated. The frequency, amplitude, and/or phase of the control signals for the acoustic transducers 208 may be adjusted to move the vibration peaks, e.g., area 216, to different points with respect to the interactive substrate 212. Moreover, the frequency, amplitude, and/or phase of the controls signals for the acoustic transducers 208 may be adjusted to control a texture felt by the user 108. For example only, a lower frequency modulation may be generated on top of a base modulation to generate a coarse texture (lower frequency) or a fine texture (higher frequency).

The texture modulation may be generated to define edges of objects displayed by the electro-acoustic touch display 200 with which the user 108 interacts via the interactive substrate 212. For example, the electro-acoustic touch display 200 may display an icon to the user 108, and the texture modulation may be generated to define the edges of the icon, which may be felt by the user 108 via the interactive substrate. Additionally, different types of surfaces may be generated using the texture modulation. For example, these surfaces could include soft/fine textures (higher frequency texture modulation), such as carpet, or rough/coarse textures (lower frequency texture modulation), such as sandpaper.

Referring now to FIG. 2B, a sectional view along line A-A of the electro-acoustic touch display 200 of FIG. 2A is illustrated. The interactive substrate 212 may be surrounded by the acoustic dampening material 204, and may be located above the acoustic transducers 208. For example, the interactive substrate 212 and the acoustic dampening material 204 may be located in a first layer 220 of the electro-acoustic touch display 200. Alternatively, the acoustic dampening material 204 may be located elsewhere, such as in a second layer 230 of the electro-acoustic touch display 200. The second layer 230 may be arranged between the first layer 220 and a third layer 240.

The second layer 230 of the electro-acoustic touch display 200 may further include the acoustic transducers 208. Alternatively, the acoustic transducers 208 may be located elsewhere such as in the first layer 220 along with the interactive substrate 212. The remainder of the second layer 230 may be air, e.g., an air gap, or another suitable material such as a dielectric. The third layer 240 may include first and second circuits 250 and 260, respectively. The first circuit 250 may include capacitive sensing circuitry for interpreting touch input by the user 108 via the interactive substrate 212. The second circuit 260 may include circuitry for controlling the acoustic transducers 208. While two circuits 250 and 260 are illustrated, it should be appreciated that a single circuit may be implemented to perform both capacitive sensing and acoustic transducer control.

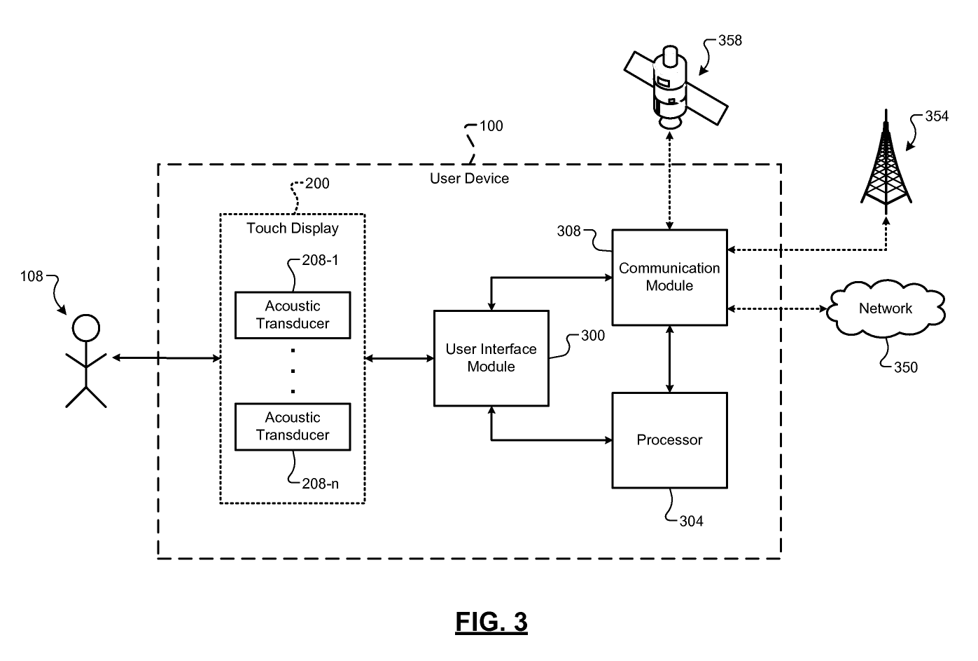

Referring now to FIG. 3, an example user device 100 including the electro-acoustic touch display 200 is illustrated. The user device 100 may further include a user interface module 300, a processor 304, and a communication module 308. It should be appreciated that the user device 100 may also include additional computing components, e.g., memory.

The user interface module 300 controls interaction between the user 108 and the user device 100. In particular, the user interface module 300 controls operation of the electro-acoustic touch display 200. The user interface module 300 may provide information to the user 108 via the electro-acoustic touch display 200 and/or receive and interpret input from the user 108 via the electro-acoustic touch display 200. For example, the input from the user 108 may include the one or more parameters, e.g., intensity and texture, used to generate the control signals for the n acoustic transducers 208-1 . . . 208-n (collectively acoustic transducers 208). The user interface module 300 may also control the acoustic transducers 208 of the electro-acoustic touch display 200 to provide tactile feedback to the user 108 (alone or in conjunction with the processor 304).

The processor 304 can control most operations of the user device 100. The processor 304, therefore, may communicate with both the user interface module 300 and the communication module 308. The processor 304 may perform tasks including, but not limited to, loading/controlling the operating system of the user device 100, loading/configuring communication parameters for the communication module 308, controlling input method editor (IME) parameters of the user interface module 300, and controlling memory storage/retrieval operations, e.g., for loading of the various parameters. The processor 304 may also interface with the user interface module 300 in generating the control signals for the acoustic transducers 208 (described in more detail below).

The communication module 308 controls communication between the user device 100 and other devices. For example only, the communication module 308 may provide for communication between the user device 100 and other user devices associated with the user device 100 via the Internet. The user device 100 may typically communicate via one or more of: a computing network 350, e.g., the Internet (hereinafter “the network 350”), a mobile telephone network 354, and a satellite network 358. Other communication mediums may also be implemented. For example, the communication module 308 may be configured for both wired and wireless network connections, e.g., radio frequency (RF) communication.

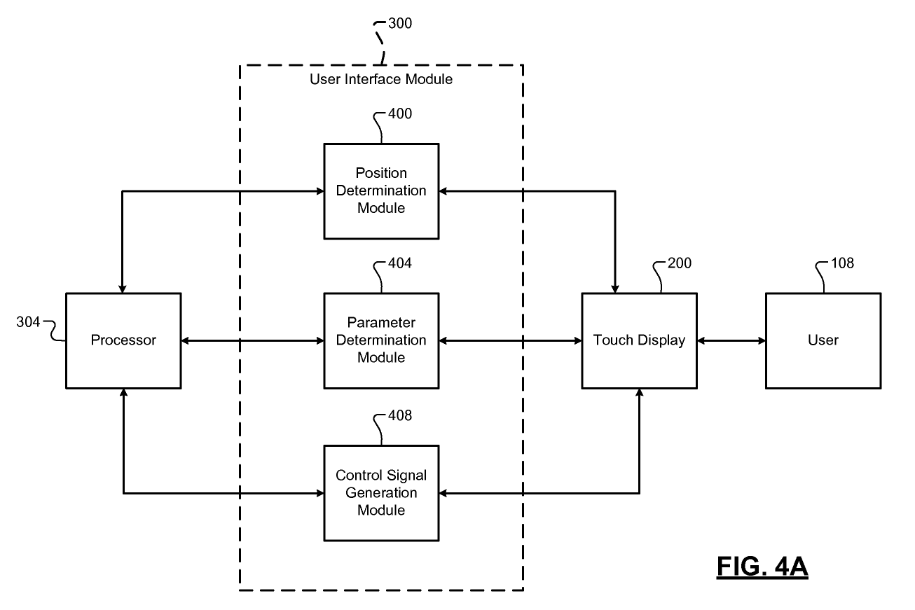

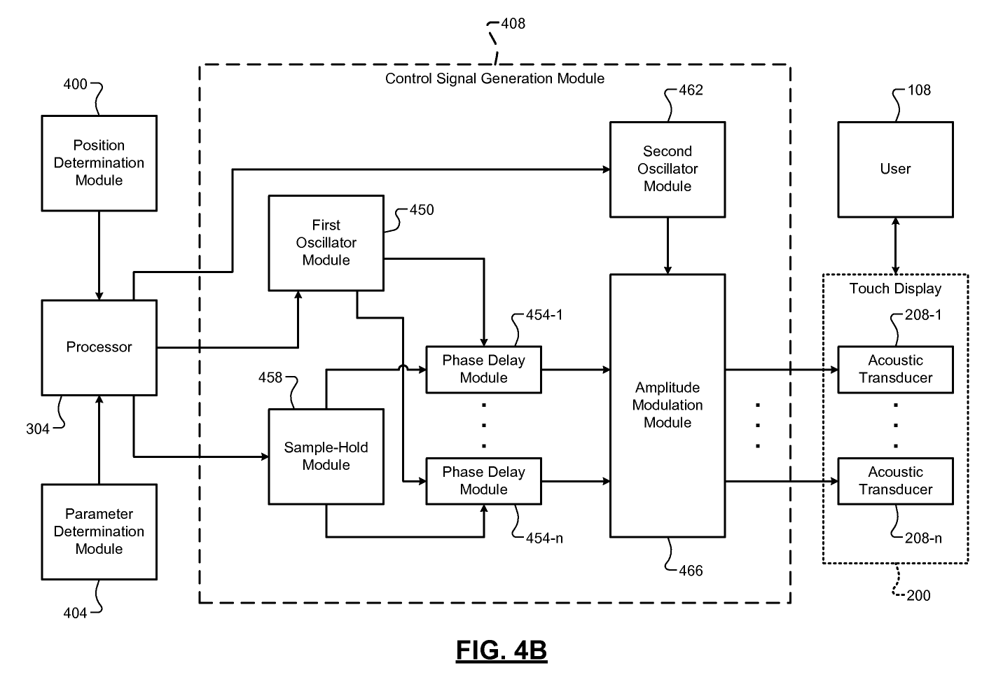

Referring now to FIG. 4A, an example user interface module 300 is illustrated. The user interface module 300 may include a position determination module 400, a parameter determination module 404, and a control signal generation module 408. It should be appreciated that the user interface module 300 may include other suitable computing components, e.g., memory.

The position determination module 400 can determines the first position of the touch input (such as the finger 112) of the user 108 with respect to the electro-acoustic touch display 200. The position determination module 400 may determine the position of the touch input of the user 108 with respect to the electro-acoustic touch display 200 using suitable sensing and/or tracking techniques. For example only, in the case of a capacitive sensing display, the position determination module 400 may determine the first position of the touch input of the user 108 when a measured capacitance at the first position increases above a predetermined threshold associated with preventing false determinations of user input. The position determination module 400 may then send the first position of the finger 112 to the processor 304 which is used in conjunction with the control signal generation module 408 to generate control signals for the acoustic transducers 208. As previously mentioned, the position determination module 400 may further determine a second position of a second touch input of the user 108 with respect to the electro-acoustic touch display 200. For example, the user 108 may interact with the electro-acoustic touch display 200 using two or more fingers 112 simultaneously.

The parameter determination module 404 can determine one or more parameters indicating a desired vibration to be felt by the user 108 at the first position. For example, the one or more parameters may be input by the user 108 and/or be predefined by the user device 100. The one or more parameters, therefore, may be stored in and retrieved from a memory (not shown). For example only, the one or more parameters may include a first parameter indicating an intensity of the desired vibration and a second parameter indicating a texture of the desired vibration. Other numbers of parameters as well as other types of parameters may also be used. Additionally, the one or more parameters may include different parameters for the desired vibrations at the different positions of the touch input by the user 108, e.g., a first set of the one or more parameters and a second set of the one or more parameters. The parameter determination module 404 may then provide the one or more parameters to the processor 304 that is used in conjunction with the control signal generation module 408 to generate control signals for the acoustic transducers 208.

The control signal generation module 408 can generate the control signals for the acoustic transducers 208. As previously described, the control signal generation module 408 may selectively generate a control signal for each of the acoustic transducers 208 based on the first position and the one or more parameters. In some situations, the control signal generation module 408 may not generate a control signal for one or more of the acoustic transducers 208, e.g., when the first position is far from a position corresponding to a particular acoustic transducer 208. Additionally, in some situations the same control signal may be generated for more than one of the acoustic transducers, e.g., when the first position is in the center of the interactive substrate or equidistant from two or more of the acoustic transducers. The control signal generation module 408 can also generate the control signals to adjust the interference of the acoustic waves generated by the acoustic transducers 208, thereby adjusting positions of vibration peaks and/or troughs, e.g., with respect to one or more fingers 112 of the user 108.

Referring now to FIG. 4B, an example control signal generation module 408 is illustrated. The control signal generation module 408 may include a first oscillator module 450, n (n>1) phase delay modules 454-1 . . . 454-n (collectively phase delay modules 454), a sample-hold module 458, a second oscillator module 462, and an amplitude modulation module 466. While generation of control signals for providing tactile feedback at a single position, e.g., one finger 112 of the user 108, it should be appreciated that the control signals may also be generated such that acoustic interference creates vibration peaks and/or troughs at two or more positions.

The first oscillator module 450 and a corresponding one of the phase delay modules 454 may be used to control the frequency of the control signal for each of the acoustic transducers 208. The processor 304 can send a frequency control signal to the first oscillator module 450, the frequency control signal being based on the one or more parameters. The first oscillator module 450 may then generate a first signal having a first frequency based on the frequency control signal. The first signal represents the frequency modulation of each control signal. The first signal can be received by each of the phase delay modules 454. The phase delay modules 454 can each be selectively enabled based on second signals generated by the sample-hold module 458.

The sample-hold module 458 and the phase delay modules 454 can be used to control the phase of the control signal for each of the acoustic transducers 208. The sample-hold module 458 can include one or more sample-hold circuits that selectively output the second signals based on one or more phase control signals generated by the processor 304. The processor 304 may generate the one or more phase control signals based on a difference between the first position and a second position of the acoustic transducer 208 associated with the particular control signal. The phase delay modules 454 may then selectively introduce a phase delay to the first signal generated by the first oscillator module 450. The phase delay modules 454 may then output third signals to the amplitude modulation module 466. The third signals represent the phase modulation of the control signals.

The second oscillator module 462 and the amplitude modulation module 466 can be used to control the amplitude of the control signal for each of the acoustic transducers 208. The processor 304 may send an amplitude control signal to the second oscillator module 462 based on the one or more parameters. The second oscillator module 462 can generate a fourth signal having a second frequency. The second frequency may be less than the first frequency of the first signal. The fourth signal is used to control the amplitude modulation module 466. As previously described, the amplitude modulation module 466 also receives the third signals output by the phase delay modules 454, which may already have modulated frequency and/or phase.

The amplitude modulation module 466 can generate and output fifth signals to the acoustic transducers 208 based on the third signals and the fourth signal. The fifth signals represent the amplitude modulation of the control signals. For example only, the third signals may be multiplied by the fourth signal. The fifth signals output by the amplitude modulation module 466, therefore, represent the control signals for the acoustic transducers 208. More specifically, each of the control signals has a desired frequency, a desired amplitude, and a desired phase to provide the desired vibration to the user 108 at the first position. Moreover, as previously described, the control signals may include both first and second modulations. The first modulation may be a base modulation used for the intensity of the desired vibration, and the second modulation may be a lower frequency modulation than the base modulation and may be used for the texture of the desired vibration. For example, the second modulation may be introduced on top of the first (base) modulation.

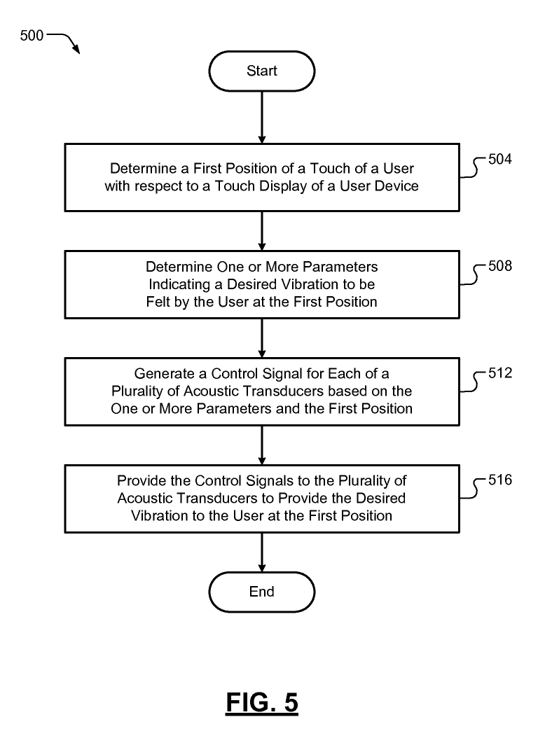

Referring now to FIG. 5, an example technique 500 for providing localized tactile feedback to the user 108 via the electro-acoustic touch display 200 of the user device 100 is illustrated. At 504, the position determination module 400 determines a first position of a touch (via finger 112, etc.) of the user 108 with respect to the electro-acoustic touch display 200 of the user device 100. The position determination module 400 may further determine a second position of a second touch of the user 108 with respect to the electro-acoustic touch display 200. At 508, the parameter determination module 404 determines one or more parameters for controlling the plurality of acoustic transducers 208 of the electro-acoustic touch display 200, the one or more parameters indicating a desired vibration to be felt by the finger 112 of the user 108 at the first position. The one or more parameters may include different parameters for different vibrations to be felt by the user at the different positions with respect to the electro-acoustic touch display 200, e.g., at two fingers 112 of the user 108. At 512, the control signal generation module 408 generates a control signal for each of the plurality of acoustic transducers 208.

The control signal generation module 408 can determine a desired frequency and/or a desired amplitude of the control signal based on the one or more parameters. The control signal generation module 408 can further determine a desired phase of the control signal based on the first position of the touch of the user 108 and a second position of one of the plurality of acoustic transducers 208 associated with the control signal. The control signal generation module 408 then generates the control signal based on the desired frequency, the desired amplitude, and the desired phase. At 516, the control signal generation module 408 provides each control signal to its associated acoustic transducer 208 to generate the desired vibration at the position of the touch of the user 108. The control signal generation module 408 may also generate the control signals such that the interference of the acoustic waves generated by the acoustic transducers 208 provides vibration peaks and/or troughs at two or more locations, e.g., to be felt by two or more fingers 112 of the user 108. Control may then end or return to 504 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

As used herein, the term module may refer to, be part of, or include: an Application Specific Integrated Circuit (ASIC); an electronic circuit; a combinational logic circuit; a field programmable gate array (FPGA); a processor or a distributed network of processors (shared, dedicated, or grouped) and storage in networked clusters or datacenters that executes code or a process; other suitable components that provide the described functionality; or a combination of some or all of the above, such as in a system-on-chip. The term module may also include memory (shared, dedicated, or grouped) that stores code executed by the one or more processors.

The term code, as used above, may include software, firmware, byte-code and/or microcode, and may refer to programs, routines, functions, classes, and/or objects. The term shared, as used above, means that some or all code from multiple modules may be executed using a single (shared) processor. In addition, some or all code from multiple modules may be stored by a single (shared) memory. The term group, as used above, means that some or all code from a single module may be executed using a group of processors. In addition, some or all code from a single module may be stored using a group of memories.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1.-23. (canceled)

24. A user device comprising:
a first layer that includes:
an interactive substrate configured to receive a first touch input from a user of the user device and defining an area, a top surface, a bottom surface, and an edge surface extending between the top surface and the bottom surface, and
an acoustic dampening material coupled to the edge surface and substantially surrounding the interactive substrate;
a second layer that includes a plurality of acoustic transducers, each of the plurality of acoustic transducers being configured to generate an acoustic wave along the interactive substrate in response to a control signal, wherein the acoustic dampening material is configured to constrain the plurality of acoustic waves within the area defined by the interactive substrate; and
a third layer that includes:
a first circuit configured to sense a first position of the first touch input from the user with respect to the interactive substrate, and
a second circuit configured to generate the control signal for each of the plurality of acoustic transducers to generate a first desired vibration at the first position of the first touch input,
wherein the second layer is arranged between the first and third layers.

25. The user device of claim 24, wherein the second layer further includes at least one of an air gap and a dielectric material between each of the plurality of acoustic transducers.

26. The user device of claim 24, wherein the first desired vibration is based on one or more parameters, wherein the one or more parameters include at least one of an intensity of the first desired vibration and a texture of the first desired vibration.

27. The user device of claim 24, wherein the first circuit is further configured to sense a second position of a second touch input from the user of the user device, wherein the second position is different than the first position.

28. The user device of claim 27, wherein the second circuit is configured to generate the control signal for each of the plurality of acoustic transducers to generate interference of the plurality of acoustic waves, the interference including the first desired vibration at the first position of the first touch input and a second desired vibration at the second position of the second touch input, the second desired vibration being different than the first desired vibration.

29. The user device of claim 28, wherein the first and second desired vibrations are based on one or more parameters, and wherein the one or more parameters include at least one of intensities of the first and second desired vibrations and textures of the first and second desired vibrations.

30. A user device comprising:
a first layer that includes:
an interactive substrate configured to receive a first touch input from a user of the user device and defining an area, a top surface, a bottom surface, and an edge surface extending between the top surface and the bottom surface,
a plurality of acoustic transducers, each of the plurality of acoustic transducers being configured to generate an acoustic wave along the interactive substrate in response to a control signal, and
an acoustic dampening material coupled to the edge surface and substantially surrounding the interactive substrate, the acoustic dampening material configured to constrain the plurality of acoustic waves within the area defined by the interactive substrate; and
a second layer that includes:
a first circuit configured to sense a first position of the first touch input from the user with respect to the interactive substrate, and
a second circuit configured to generate the control signal for each of the plurality of acoustic transducers to generate a first desired vibration at the first position of the first touch input,
wherein the second layer is arranged below the first layer.

31. The user device of claim 30, wherein the first desired vibration is based on one or more parameters, wherein the one or more parameters include at least one of an intensity of the first desired vibration and a texture of the first desired vibration.

32. The user device of claim 30, wherein the first circuit is further configured to sense a second position of a second touch input from the user of the user device, wherein the second position is different than the first position.

33. The user device of claim 32, wherein the second circuit is configured to generate the control signal for each of the plurality of acoustic transducers to generate interference of the plurality of acoustic waves, the interference including the first desired vibration at the first position of the first touch input and a second desired vibration at the second position of the second touch input, the second desired vibration being different than the first desired vibration.

34. The user device of claim 33, wherein the first and second desired vibrations are based on one or more parameters, and wherein the one or more parameters include at least one of intensities of the first and second desired vibrations and textures of the first and second desired vibrations.

35. A system comprising:
a position determination module that determines, at a user device, a first position of a first touch of a user with respect to a touch display of the user device and a second position of a second touch of the user with respect to the touch display of the user device;
a parameter determination module that determines, at the user device, two or more parameters for controlling a plurality of acoustic transducers of the touch display, the two or more parameters indicating a first desired vibration to be felt by the user at the first position and a second desired vibration to be felt by the user the second position, the two or more parameters including a first intensity of the first desired vibration and a first texture of the first desired vibration and a second intensity of the second desired vibration and a second texture of the second desired vibration, wherein at least one of the first intensity and the first texture is different than the second intensity and the second texture, respectively; and
a control signal generation module that generates, at the user device, a control signal for each of the plurality of acoustic transducers, wherein generating the control signal includes:
determining a desired frequency of the control signal based on the two or more parameters,
determining a desired amplitude of the control signal based on the two or more parameters,
determining a desired phase of the control signal based on the first and second positions of the touch of the user and a relative position of one of the plurality of acoustic transducers associated with the control signal, and
generating the control signal based on the desired frequency, the desired amplitude, and the desired phase,
wherein the control signal generation module provides each control signal to its associated acoustic transducer to generate an interference of the plurality of acoustic waves generated by the plurality of acoustic transducers, wherein the interference includes the first desired vibration at the first position of the first touch of the user and the second desired vibration at the second position of the second touch of the user, wherein each magnitude of the first and second desired vibrations is greater than zero, and wherein each of the plurality of acoustic transducers is located at a different location than the first position of the first touch of the user and the second position of the second touch of the user.

36. The system of claim 35, wherein the two or more parameters are at least one of predefined for the user device and selected by the user via the user device.

37. (canceled)

38. The system of claim 35, wherein the control signal for each of the plurality of acoustic transducers includes a first modulation and a second modulation, wherein the first modulation is based on the first and second intensities of the first and second desired vibrations, respectively and wherein the second modulation is based on the first and second textures of the first and second desired vibrations, respectively.

39. The system of claim 38, wherein the second modulation has a lower frequency than the first modulation.

40. A computer-implemented method comprising:
determining, at a user device, a first position of a first touch of a user with respect to a touch display of the user device and a second position of a second touch of a user with respect to the touch display of the user device;
determining, at the user device, two or more parameters for controlling a plurality of acoustic transducers of the touch display, the two or more parameters indicating a first desired vibration to be felt by the user at the first position and a second desired vibration to be felt by the user at the second position, the two or more parameters including a first intensity of the first desired vibration and a first texture of the first desired vibration and a second intensity of the second desired vibration and a second texture of the second desired vibration, wherein at least one of the first intensity and the first texture is different than the second intensity and the second texture, respectively;
generating, at the user device, a control signal for each of the plurality of acoustic transducers, wherein generating the control signal includes:
determining a desired frequency of the control signal based on the two or more parameters,
determining a desired amplitude of the control signal based on the two or more parameters,
determining a desired phase of the control signal based on the first and second positions of the touch of the user and a relative position of one of the plurality of acoustic transducers associated with the control signal, and
generating the control signal based on the desired frequency, the desired amplitude, and the desired phase; and
providing each control signal to its associated acoustic transducer to generate an interference of the plurality of acoustic waves generated by the plurality of acoustic transducers, wherein the interference includes the first desired vibration at the first position of the first touch of the user and the second desired vibration at the second position of the second touch of the user, wherein each magnitude of the first and second desired vibrations is greater than zero, and wherein each of the plurality of acoustic transducers is located at a different location than the first position of the first touch of the user and the second position of the second touch of the user.

41. The computer-implemented method of claim 40, wherein the two or more parameters are at least one of predefined for the user device and selected by the user via the user device.

42. (canceled)

43. The computer-implemented method of claim 40, wherein the control signal for each of the plurality of acoustic transducers includes a first modulation and a second modulation, wherein the first modulation is based on the first and second intensities of the first and second desired vibrations, respectively, and wherein the second modulation is based on the first and second textures of the first and second desired vibrations, respectively.

44. The computer-implemented method of claim 43, wherein the second modulation has a lower frequency than the first modulation.
